(19) United States
(12) Patent Application Publication
(10) Pub. No.: US 2013/0290560 A1
(43) Pub. Date: Oct. 31, 2013

(54) SYSTEMS AND METHODS FOR DETERMINING ROUTES IN NETWORKS

(71) Applicant: Rituparna Chaki, Kolkata (IN)

(72) Inventor: Rituparna Chaki, Kolkata (IN)

(73) Assignee: WEST BENGAL UNIVERSITY OF TECHNOLOGY, Kolkata (IN)

(21) Appl. No.: 13/881,148

(22) PCT Filed: Nov. 30, 2010
(86) PCT No.: PCT/IB10/03055

§ 371 Date: Jul. 9, 2013

(30) Foreign Application Priority Data
Aug. 26, 2010 (IN) 964/KOL/2010

(51) Int. Cl. H04W 40/02

(52) U.S. Cl. CPC H04W 40/02
USPC 709/238

(57) ABSTRACT

The disclosure describes systems and methods for determining a route in a network. A method according, to one embodiment includes determining a set of neighbor nodes that are within wireless communications range of a current node, determining that a route is needed from a source to a destination node, selecting a first neighbor node that is located closest to the destination node as the next hop in the route, and sending:a route-request message to the first neighbor node. The process continues on a hop-by-hop basis until reaching the destination node, whereupon a route-reply message is sent beck to the source node confirming that the route has been determined.

### CROSS-REFERENCE TO RELATED APPLICATIONS

This application claims priority to Indian Application Serial No. 964/KOL/2010 filed on Aug. 26, 2010, the entire contents of which are incorporated herein by reference.

### BACKGROUND

Routing protocols allow network nodes to route data traffic across a network. In general, routing protocols can generally be classified into two broad categories: proactive protocols and reactive protocols.

Proactive protocols attempt to maintain consistent and updated routing information for all network nodes by proactively updating route information at network nodes at regular intervals. Because proactive protocols typically require each node to maintain large tables of routing information, proactive protocols are sometimes referred to table-driven protocols. Examples of proactive protocols include the Destination Sequence Distance Vector (DSDV) routing protocol, the Temporary Ordered Routing Algorithm (TORA) routing protocol, the Wireless Routing Protocol (WRP), and the Fish eye State Routing (FSR) protocol, among others.

In contrast to proactive protocols, reactive protocols establish a route from a source to a destination when there is an actual demand for the route. Because reactive protocols identify and establish routes only when required, reactive protocols typically use less bandwidth for management and control packets than proactive algorithms that may use significant management and control bandwidth for periodic table update messaging. Examples of reactive routing protocols include the Location-Aided Routing (LAR) protocol, the Dynamic Source Routing (DSR) protocol, the Ad-hoc On-demand Distance Vector (AODV) routing protocol, the Location Prediction-Based Reactive Routing Protocol (LBRP) and the Location-based Directional Route Discovery (LDRD) routing protocol, among others.

### SUMMARY

Systems and methods for determining routes in networks are described herein. The networks described in the present disclosure generally include a plurality of nodes, and each node has a corresponding set of neighbor nodes.

A method according to one of the disclosed embodiments includes determining a set of neighbor nodes that are within wireless communications range of a given current node, determining that a route is needed from a source node to a destination node, and selecting a first neighbor node in response to determining that the route is needed. In some embodiments, the first neighbor node is the neighbor node that is located closest to the destination node. The method also includes sending a route-request message to the first neighbor node. The route-request message may include information identifying the source and destination nodes, such as, for example, a source node identifier corresponding to the node that originated the route-request, a destination node identifier corresponding to the destination node, and location information for to the destination node. Some embodiments may include receiving a route-reply message in response to the route-request message. The route-reply message may include information associated with the route from the source node to the destination node. Some embodiments may also include updating a list of routes at the current node based on the route-reply message.

Some embodiments may include determining that a route to the destination node should not include the first neighbor node and then selecting a second neighbor node located closer to the current node than the first neighbor node. These embodiments also include sending a route-request message to the second neighbor node. These embodiments may also include refraining from sending at least one subsequent route-request message to the first neighbor node after determining that the route to the destination node should not include the first neighbor node.

Embodiments Where the current node is the source node may further include determining that the route is needed from the source node to the destination node based on data originating at the current node. Embodiments where the current node is an intermediate node located between the source node and the destination node may further include determining that the route is needed from the source node to the destination node based on receiving a route-request message.

For embodiments where the first neighbor node is the neighbor node of the set located closest to the destination node, the method may include calculating for each neighbor node of the set of neighbor nodes, a corresponding intersect point where a line drawn from the neighbor node would perpendicularly intersect a reference line. In some embodiments, the reference line may be defined by the equation y(x)=((y_{d}−y_{c})/(x_{d}−x_{c}))*(x−x_{c})+y_{c}, where (x_{c}, y_{c}) represents the location of the current node and where (x_{d}, y_{d}) represents the location of the destination node. In this embodiment, the neighbor node selected as the first neighbor node has a corresponding intersect point on the reference line that is closer to the destination node than other intersect points corresponding to other neighbor nodes.

Some embodiments of the disclosed systems include one or more communications interfaces and one or more processors configured to implement one or more aspects of the disclosed methods. Additionally, some embodiments may also a include tangible computer readable media with encoded instructions for performing one or more aspects of the disclosed methods.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 shows an example network with a plurality of nodes.

FIGS. 2A, 2B, 2C, 2D, and 2E show the discovery of a route from a source node to a destination node in a network according to illustrative embodiments.

FIGS. 3A, 3B, 3C, 3D, 3E, and 3F show the discovery of a route from a source node to a destination node in a network according to other illustrative embodiments.

FIGS. 4A and 4B show methods for discovering routes in a network according to illustrative embodiments.

FIG. 4C shows an algorithm for discovering routes in a network according to illustrative embodiments.

FIG. 5 shows a computing device that can be configured to discover routes in a network according to illustrative embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

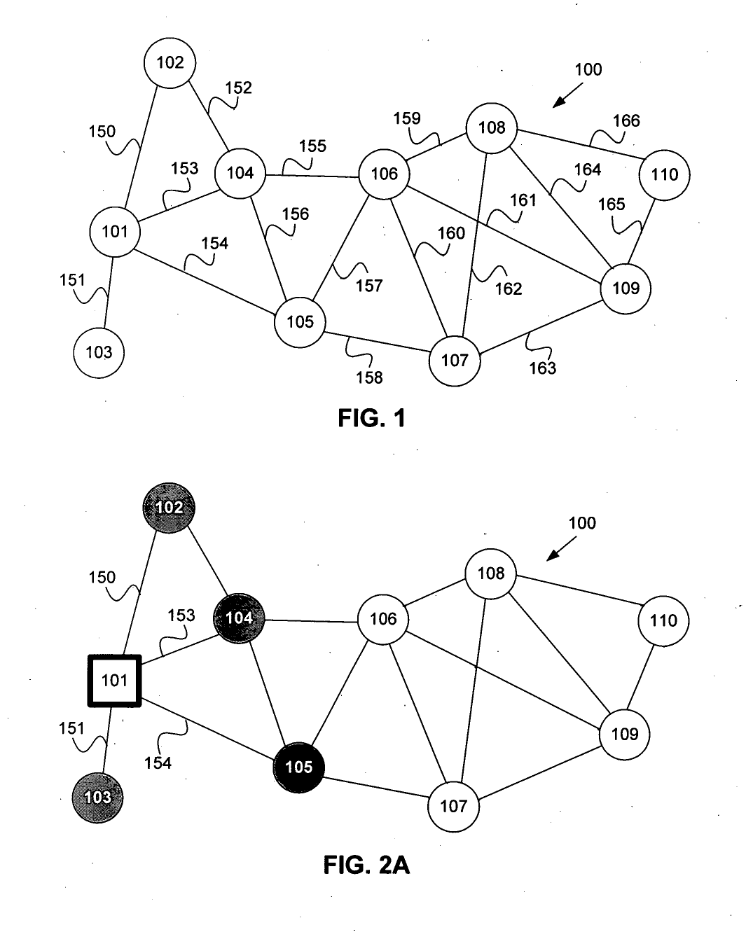

FIG. 1 shows network 100. Network 100 includes a plurality of nodes 101-110. Network 100 may be either a wireless or a wireline network. For embodiments where network 100 represents a wireline network, edges 150-166 represent network links between the nodes. For embodiments where network 100 represents a wireless network, edges 150-166 indicate that two nodes are within wireless transmission range of one another, i.e., the two nodes can send and/or receive data via wireless transmission/receiver interfaces to and/or from one another. Nodes that are within wireless transmission range of one other are referred to as neighbor nodes. For example, in FIG. 1, node 101 is within wireless transmission range of nodes 102, 103, 104, and 105, and thus, nodes 102, 103, 104, and 105 are considered neighbor nodes of node 101.

In some embodiments, network 100 may correspond to a mobile ad-hoc network (MANET). A MANET is a self-configuring network of mobile devices connected by wireless links where some (or all) of the MANET nodes route data traffic among themselves. Because MANET nodes are free to move independently in any direction, the network topology of a MANET may change quite frequently which, in turn, poses special challenges for determining and maintaining routes in the network. Aspects of the disclosed embodiments address the challenges inherent in determining and maintaining routes where network topology may change frequently, such as, for example, MANETs. However, the disclosed embodiments are not limited to MANETs or any other particular type of network.

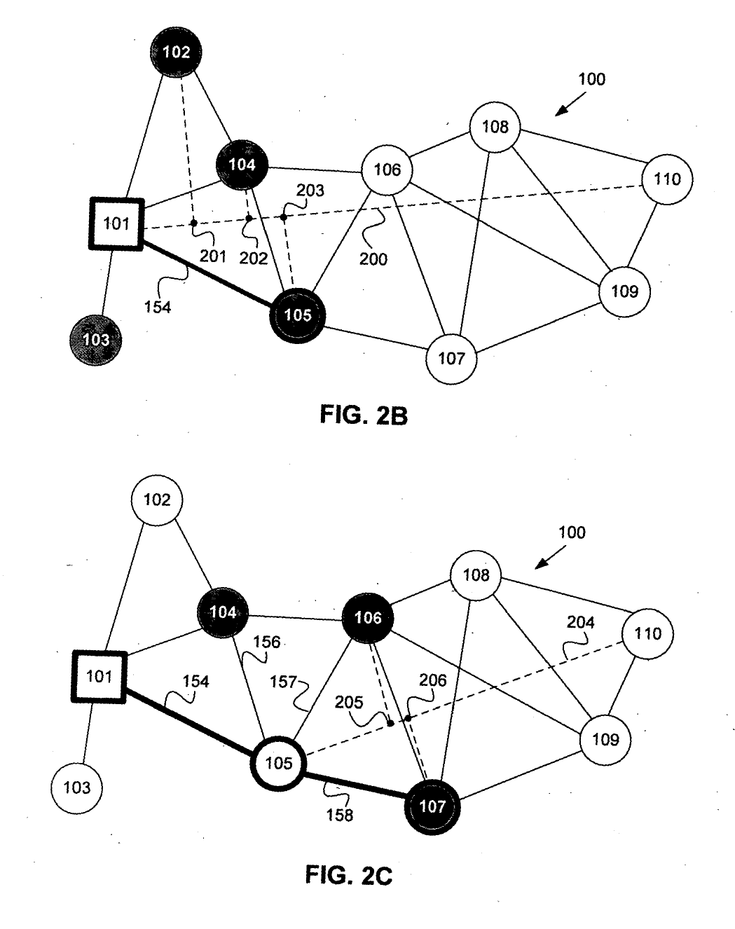

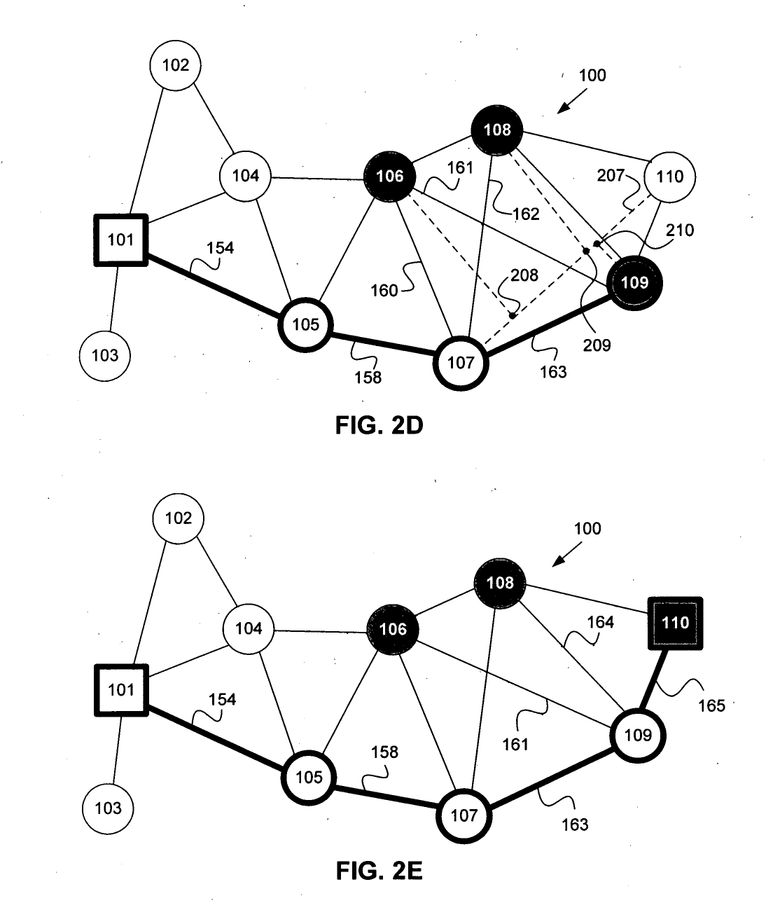

FIGS. 2A-2E illustrate the determination of a route from node 101 to node 110 in network 100 according to some embodiments. The route determination process begins at node 101 when node 101 determines that it needs to determine a route to node 110. In the example shown in FIGS. 2A-2E, node 101 is referred to as a source node because it originates a route-request message, and node 110 is referred to as a destination node because it is end-point of the route requested the route-request Message. As shown in FIGS. 2A-2E, the route determination process proceeds on a hop-by-hop basis from node 101 to node 110. Source node 101 and the intermediate nodes between source node 101 and destination node 110 perform substantially the same functions to determine the next hop in the route until the route from node 101 to node 110 has been determined.

In FIG. 2A, node 101 determines a set of one or more neighbor nodes. In one embodiment, node 101 may determine its neighbor nodes in response to determining that the route is needed to node 110. Alternatively, node 101 may have previously determined its neighbor nodes before determining that it needs a route to node 110. Either way, determining neighbor nodes can be accomplished via any of a number of neighbor discovery protocols. For example, a node may advertise its presence (and, in some embodiments, its location) with a wireless broadcast message, and one or more nodes within wireless transmission range of the advertising node may respond with an acknowledgement that includes an indication of their identity (and, in some embodiments, their location). For example, in FIG. 1A, node 101 may use any of a number of neighbor discovery protocols to determine that its set of neighbor nodes includes nodes 102, 103, 104, and 105. For illustration purposes, nodes 102, 103, 104, and 105 are shaded in FIG. 1A to indicate that they are neighbor nodes to node 101 and that they can communicate with node 101 via wireless transmission paths 150, 151, 153, and 154, respectively.

After determining that it needs a route to node 110, and once the neighbor nodes are known, node 101 can then select one of its neighbor nodes 102, 103, 104, or 105 as the next hop for creating the route from node 101 to node 110. In the embodiment shown in FIG. 2B, node 101 has selected neighbor node 105 as the next hop along the route to 110 because node 105 is closer to node 110 than the rest of neighbor nodes 102, 103, and 104. There are multiple ways that a given node can determine which of its neighbor nodes is closest to a destination node. In one embodiment, the given node can calculate a group of intersect points where lines drawn from its corresponding neighbor nodes would perpendicularly intersect a reference line drawn from the given node to the destination node. Then, the given node can select the neighbor node corresponding to the intersect point closest to the destination node as the next hop. For example, in FIG. 2B, node 101 calculates intersect points 201, 202, and 203 that correspond to locations where lines drawn from corresponding neighbor nodes 102, 104, and 105 would perpendicularly intersect reference line 200 drawn from node 101 to node 110. An intersect point for node 103 is not calculated because a line drawn from node 103 cannot perpendicularly intersect reference line 200. Because intersect point 203 corresponding to node 105 is closet to node 110 than intersect points 201 and 202 corresponding to nodes 102 and 104, respectively, node 101 selects node 105 as the next hop for the route from node 101 to node 110.

After selecting node 105 as the next hop, node 101 then sends a route-request message to node 105. The route-request message sent from node 101 to node 105 may include information related to source node 101 and destination node 110, such as node identification and location information (e.g., GPS coordinates and/or other location information). For example, the route-request message may include a source identifier corresponding to node 101, a destination identifier corresponding to node 110, and location information corresponding to node 110. The route-request message may also include a route identifier. The requested route could also be identified based on source node and destination node identifiers.

FIG. 2C shows node 105 determining a next hop in the route determination process in response to receiving the route-request message from node 101. In one embodiment, node 105 determines its set of neighbor nodes after receiving the route-request message from node 101. Alternatively, node 105 may have previously determined its set neighbor nodes before receiving the route-request message. In either ease, after receiving the route-request message, and once the neighbor nodes are known, node 105 can then select one of its neighbor nodes 101, 104, 106, or 107 as the next hop for the route from node 101 to node 110. In FIG. 2C, node 15 has selected neighbor node 107 as the next hop for the route to 110 because node 107 is closer to node 110 than neighbor nodes 101, 104, and 106. Similar to the process described for node 101 in FIG. 2B, node 105 calculates intersect points 205 and 206 that correspond to locations where lines drawn from corresponding neighbor nodes 106 and 107 would perpendicularly intersect reference line 204 drawn from node 105 to node 110. Intersect points for nodes 101 and 104 are not calculated because lines drawn from nodes 101 or 104 cannot perpendicularly intersect reference line 204. Because intersect point 206 corresponding to node 107 is closer to node 110 than intersect point 205 corresponding to node 106, node 105 selects node 107 as the next hop for the route from node 101 to node 110. After selecting node 107 as the next hop, node 105 then sends a route-request message to node 107. The route-request message may include identification and location information related to source node 101 and destination node 110. The route-request message may also include identification and location information related to intermediate node 105 in some embodiments.

FIG. 2D shows node 107 determining a next hop in the route- determination process in response to receiving the route-request message from node 105. Node 107 may determine its neighbor nodes before or after receiving the route-request message from node 105. But after receiving the route-request message from node 105, and once its neighbor nodes are known, node 107 can select one of its neighbor nodes 105, 106, 108, or 109 as the next hop for the route from node 101 to node 110. In the embodiment shown in FIG. 2D, node 107 selects neighbor node 109 as the next hop for the route to 110 because node 109 is closer to node 110 than neighbor nodes 105 106, and 108. Similar to the process described for nodes 101 and 105 in FIGS. 2B and 2C, node 107 calculates intersect points 208, 209, and 210 that correspond to locations, where lines drawn from corresponding neighbor nodes 106, 108, and 109 would perpendicularly intersect reference line 207 drawn from node 107 to node 110. An intersect point for node 105 is not calculated because a line drawn from node 105 cannot perpendicularly intersect reference line 207. Because intersect point 210 corresponding to node 109 is closer to node 110 than intersect points 208 or 209 corresponding to nodes 106 and 108, node 107 selects node 109 as the next hop for the route from node 101 to node 110. After selecting node 109 as the next hop, node 107 then sends a route-request message to node 109. As described above, the route-request message may include identification and location information related nodes 101 and 110. And in some embodiments, the route-request message may also include identification and location information related to intermediate nodes 105 and 107.

FIG. 2E shows node 109 determining a next hop in the route determination process in response to receiving the route-request message from node 107. Node 109 may determine its neighbor nodes before or after receiving the route-request message from node 107. But after receiving the route-request message from node 107, and once the neighbor nodes are known, node 109 then selects one of its neighbor nodes 107, 106, 108, or 110 as the next hop for the route from node 101 to node 110. And because destination node 110 is a neighbor of node 109, node 109 selects node 110 as the next hop.

In one embodiment, after selecting node 110 as the next hop, node 109 may send a route-reply message back to node 101 via nodes 107 and 105. In another embodiment, after selecting node 110 as the next hop, node 109 may send a route-request message to node 110, and node 110 may then send the route-reply message back to node 101 via nodes 109, 107, and 105. In one embodiment, the route-reply message contains an acknowledgement that the route has been confirmed. In another embodiment, the route-reply message may also include information related to the route, such as, for example, information related to one or more of the nodes along the route from node 101 to node 110 (i.e., nodes 101, 105, 107, 109, and 110). In other embodiments, each node that receives and processes the route-reply message may update a local list of routes.

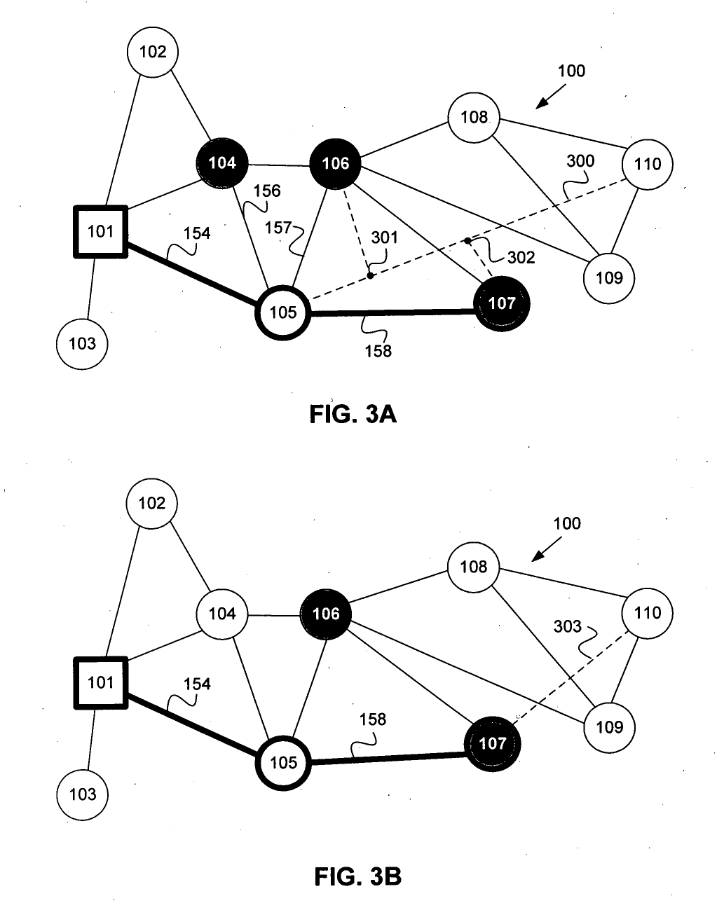

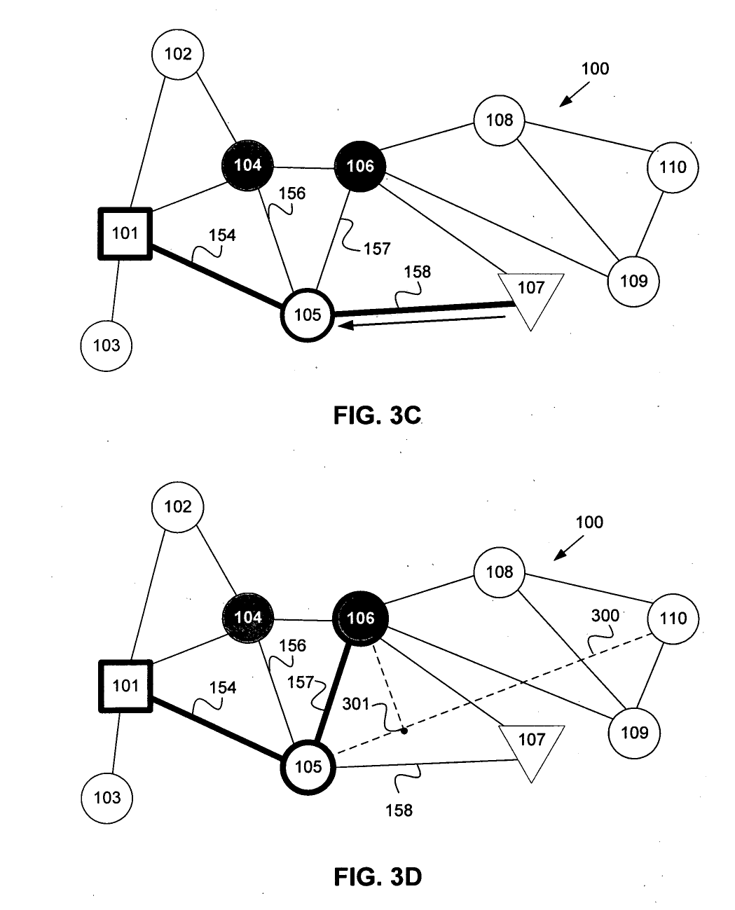

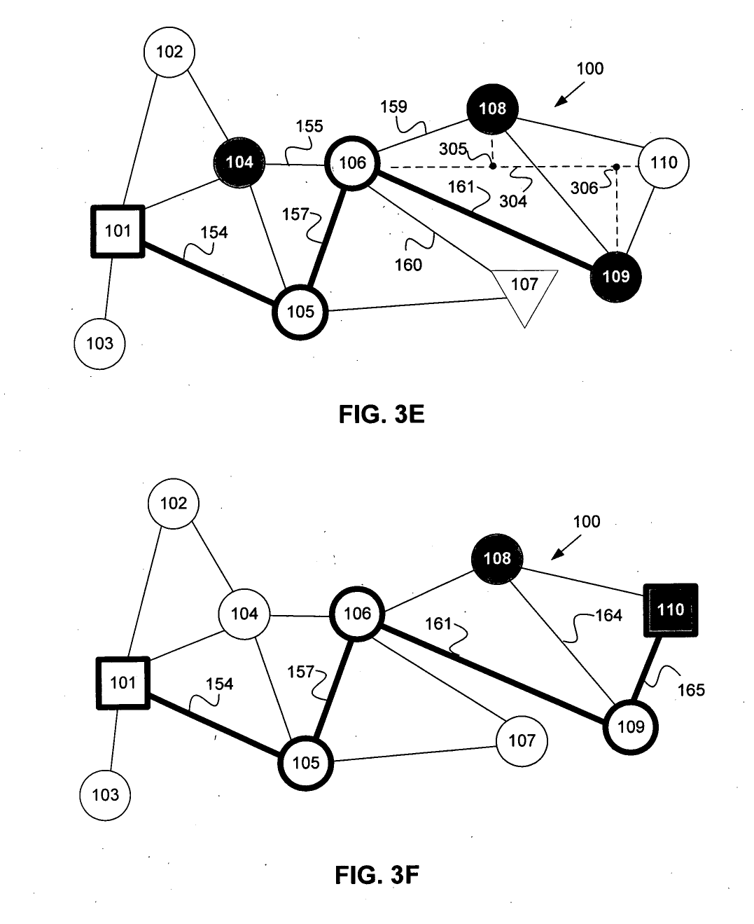

FIGS. 3A-3F illustrate the determination of a route in network 100 in situations where a route cannot or should not be completed through a particular neighbor node for some reason. For example, a route cannot or should not be completed through a particular neighbor node when doing so might: (i) use network resources inefficiently by creating unnecessary hops: in the route; (ii) cause the particular neighbor node to exceed a maximum threshold number of routes; and/or (iii) cause the particular neighbor node to exceed a maximum threshold data throughput.

In FIG. 3A, node 105 has already received a route-request message from node 101. After receiving the route-request message, and once the neighbor nodes are known, node 105 starts the process of selecting one of its neighbor nodes 101, 104, 106, or 107 as the next hop. In FIG. 3A, node 105 selects neighbor node 107 as the next hop because node 107 is closer to node 110 than neighbor nodes 101, 104, and 106. And after selecting node 107 as the next hop, node 105 then sends a route-request message to node 107.

In FIG. 3B, node 107 tries to determine which of its neighbor nodes should be selected as the next hop for the route to node 110. In contrast to the network shown in FIGS. 1 and 2A-2E, nodes 108 and 109 are not among node 107's neighbor nodes. When node. 107 attempts to calculate intersect points on reference line 303, it determines that lines drawn from its neighbor nodes (nodes 105 and 106) cannot perpendicularly intersect reference line 303. As a result, node 107 determines that it should not be an intermediate node in the route from node 101 to node 110 (i.e., the route from node 101 to node 110 should not include node 107) because, for example, the resulting route would use network resources inefficiently by routing data through unnecessary intermediate nodes.

In response to determining that it should not be an intermediate node in the route from node 101 to node 110, node 107 may send a notification to node 105. Node 107 may also send notifications to its other neighbor nodes (i.e., nodes 105 and 107) regarding its unsuitability for completing routes to node 110. In other embodiments, a node may selectively inform other neighbor nodes that it is unavailable to complete a route to a desired destination node in response to receiving a subsequent route-request message from one of its other neighbor nodes. For illustration purposes, node 107 is shown as a triangle to indicate that it should not be an intermediate node in a route from node 101 to node 110.

In FIG. 3C, node 105 determines that node 107 is unsuitable (or otherwise unavailable) to complete a route to node 110 based on a notification from node 107. In FIG. 3D, once node 105 determines that node 107 is not available to complete a route to node 110, node 105 selects a new neighbor node as the next hop for the route to node 110 by calculating intersect point 301 that corresponds to the location where a line from neighbor node 106 would perpendicularly intersect reference line 300 drawn from node 105 to node 110. Intersect points for nodes 101 and 104 are not calculated because a line drawn from nodes 101 and 104 cannot perpendicularly intersect reference line 300. An intersect point for node 107 is not calculated because it is unavailable to complete a route to node 110. In alternative embodiment, node 105 may have previously ranked neighbor nodes 106 and 107 based on their corresponding intersect points, and rather than recalculating new intersect points, node 105 may simply select the next-best neighbor node, which in this case is 106. Either way, node 105 selects node 106 as the next hop for the route to node 101 to node 110, and node 105 sends a route-request message to node 106. In FIG. 3E, node 106 selects node 109 for the next hop in the route to node 110. And then in FIG. 3F, node 109 selects node 110 for the next hop to complete the route from node 101 to node 110.

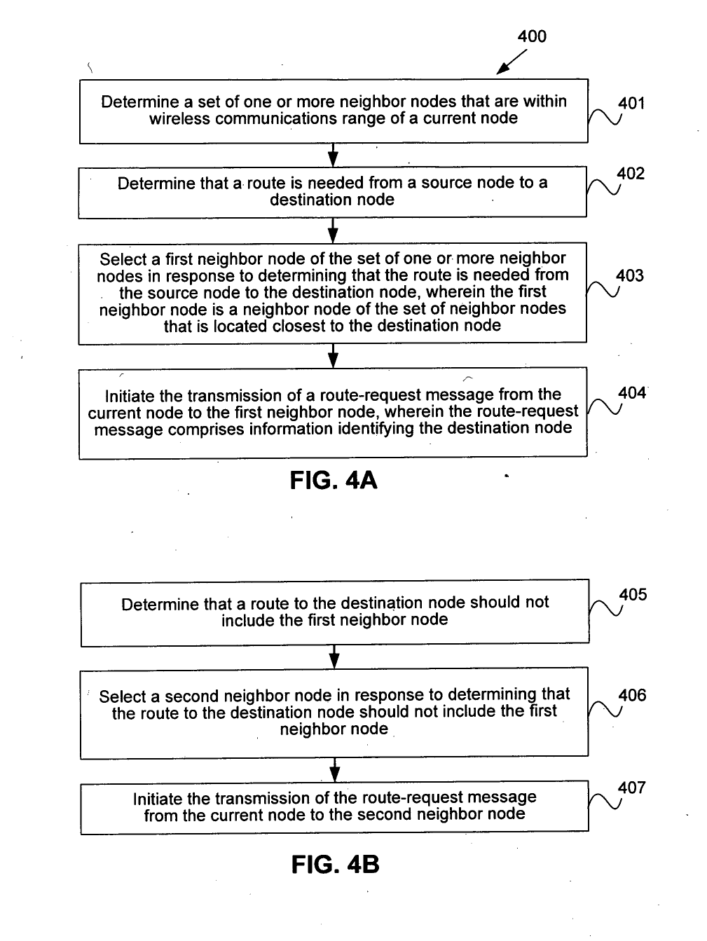

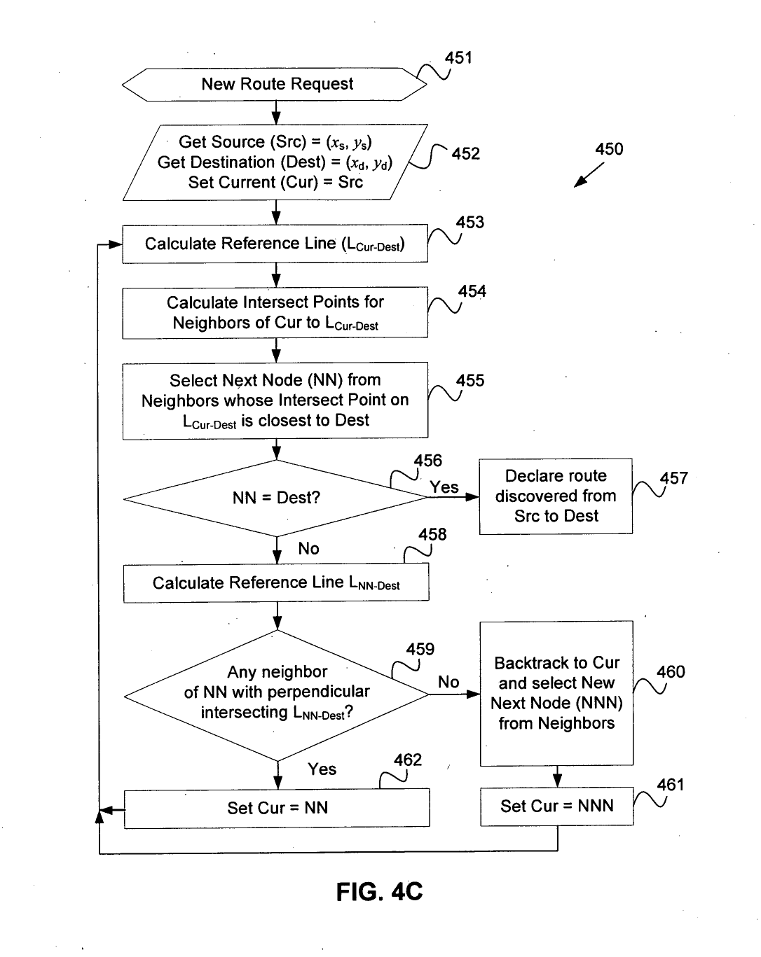

FIG. 4A shows one example method 400 that a current node may follow for determining a route from a source node to a destination node. At step 401, the current node determines a set of one or more neighbor nodes that are within wireless communications range. At step 402, the current node determines that a route is needed from the source node to the destination node. The current node may determine its neighbor nodes before determining that a route is needed, or the current node may determine its neighbor nodes in response to determining that a route is needed. When the current node is the source node, the determination that a route is needed may be based on data that originates at the current node. When the current node is an intermediate node located somewhere between the source node and the destination node, the determination that a route is needed may be based on receiving route-request message from the source node or from some other intermediate node.

At step 403, the current node selects a first neighbor node of its corresponding set of neighbor nodes in response to determining that the route is needed from the source node to the destination node. In one embodiment the first neighbor node may be the neighbor node that is located closest to the destination node. In another embodiment, the first neighbor node may be the neighbor node that is located farthest from the current node:

In some embodiments, the current node may select the first neighbor node by calculating a corresponding intersect point for each neighbor node where a line drawn from the neighbor node would perpendicularly intersect a reference line defined by the equation y(x)=((y_{d}−y_{c})/(x_{d}−x_{c}))*(x−x_{c})+y_{c}, where (x_{c}, y_{c}) represents a location of the current node and (x_{d}, y_{d}) represents a location of the destination node. The current node may then select the neighbor node having the corresponding intersect point on the reference line that is closest to the destination node as the first neighbor node.

The current node may alternatively select the first neighbor node based on other criteria. For example, in some embodiments, the first neighbor node may be selected from the set neighbor nodes based on one or more transmission channel characteristics of the wireless links between the current node and its neighbor nodes, e.g., signal-to-noise ratio, channel bandwidth, channel availability, etc. The first neighbor node may also be selected based one or more characteristics of each neighbor node, e.g., dropped packet history, whether a given node is a fast-moving or slow-moving node, the number of active routes in which the neighbor node participates as an intermediate node, traffic congestion at the neighbor node, etc. After selecting the first neighbor node at step 403, the current node initiates the transmission of a route-request message to the first neighbor node at step 404. The route-request message includes information identifying the destination node.

FIG. 4B shows additional method steps that a current node may follow when determining a route from a source node to a destination node. At step 405, the current node may determine that the route from the source node to the destination node should not include the previously selected first neighbor node. In one embodiment, the current node may determine that the route to the destination node should not include selected first neighbor node based on message received from the first neighbor node. The first neighbor node may inform the current node that the neighbor node is unsuitable or unavailable to complete the route for any of a number of reasons. In some embodiments, the first neighbor node may inform the current node that it is unavailable to complete the route because completing the route via the first neighbor node might: (i) use network resources inefficiently by creating unnecessary hops in the route; (ii) cause the first neighbor node to exceed a maximum threshold number of routes; and/or (iii) cause the first neighbor node to exceed a maximum threshold data throughput.

In response to determining that the first neighbor node cannot or should not complete a route to the destination node, the current node may refrain from sending one or more subsequent route-request messages to the first neighbor node (if the subsequent route-request message is associated with the same destination node). In some embodiments, the first neighbor node may send similar notifications to each of its neighbor nodes to prevent its neighbor nodes from sending it one or more subsequent route-request messages associated with the same destination node. Preventing one or more subsequent route-request messages associated with the same destination node from being sent to the first neighbor node helps avoid routing loops and reduce unnecessary route-request messages.

At step 405, the current node selects a second neighbor node in response to determining that the route to the destination node should not include the first neighbor node. In one embodiment, the second neighbor node is closer to the current node that the previously selected first neighbor node. But in other embodiments where the selection of the first neighbor node may not have been based on location, the second node might not be closer to the current node than the first neighbor node. Instead, the selection of the second neighbor node may be based on: (i) one or more transmission channel characteristics of the wireless link between the current node and the first neighbor node, e.g., signal-to-noise ratio, channel bandwidth, channel availability, etc. The second neighbor node may also be selected based one or more characteristics of the second neighbor node, e.g., dropped packet history, whether the node is a fast-moving or slow-moving node, number of active routes, traffic congestion, etc. After selecting the second neighbor node at step 406, the current node initiates the transmission of a route-request message to the second neighbor node at step 407.

FIG. 4C shows an algorithm 450 that illustrates aspects of the disclosed route determination procedures at a network level. Various aspects of algorithm 450 can be implemented in any of a number of programming languages and encoded on computer readable media for execution by one or more processors at any node in a network such as network 100 shown in FIGS. 1-3.

Algorithm 450 starts at step 451 with a new route request at a Source Node (Src.). At step 452, the Source Node coordinates (xₛ, yₛ) and the Destination Node coordinates (x_{d}, y_{d}) are identified, and the Source Node is set as the Current Node. At step 453, the Current Node calculates a Reference Line from the Current Node to the Destination Node (L_{Cur-Dest}). In some embodiments, the Reference Line (L_{Cur-Dest}) may be defined by the equation y(x)=((y_{d}−yₛ)/(x_{d}−xₛ))*(x−xₛ)+yₛ.

At step 454, the Current Node calculates a group of Intersect Points where lines drawn from the Current Node's corresponding Neighbor Nodes would perpendicularly intersect the Reference Line (L_{Cur-Dest}). At step 455, the Current Node selects the Neighbor Node corresponding to the Intersect Point closest to the Destination Node as the Next Node.

At step 456, the Current Node determines if the Next Node is the Destination Node. And if the Next Node is the Destination Node, then the Current Node declares the Route from the Source Node to the Destination Node discovered at step 457. But if the Next Node is not the Destination Node, then the Current Node sends a route-request message to the Next Node. At step 458, the Next Node calculates a Reference Line (L_{NN-Dest}) from the Next Node to the Destination Node. In some embodiments, the Reference Line (L_{NN-Dest}) may be defined by the equation y(x)=((y_{d}−y_{NN})/(x_{d}−x_{NN}))*(x−x_{NN})+y_{NN}, where coordinates (x_{NN}, y_{NN}) are the coordinates of the Next Node, and where (x_{d}, y_{d}) are the coordinates of the Destination Node. At step 459, the Next Node determines whether there are any Intersect Points where lines drawn from any of the Next Node's corresponding Neighbor Nodes would perpendicularly intersect the Reference Line (L_{NN-Dest}).

If the Next Node has no corresponding Neighbor Nodes that would have a corresponding Intersect Point on Reference Line (L_{NN-Dest}), then the Current Node can then select a New Next Node (NNN) from the Current. Node's corresponding Neighbor Nodes at step 460. The New Next Node can be set to the Current Node at step 461, and the process can return to step 453. But if the Next Node has at least one corresponding Neighbor Node with a corresponding. Intersect Point on Reference Line (L_{NN-Dest}), then the Next Node can be set to the Current Node at step 462, and the process can return to step 453.

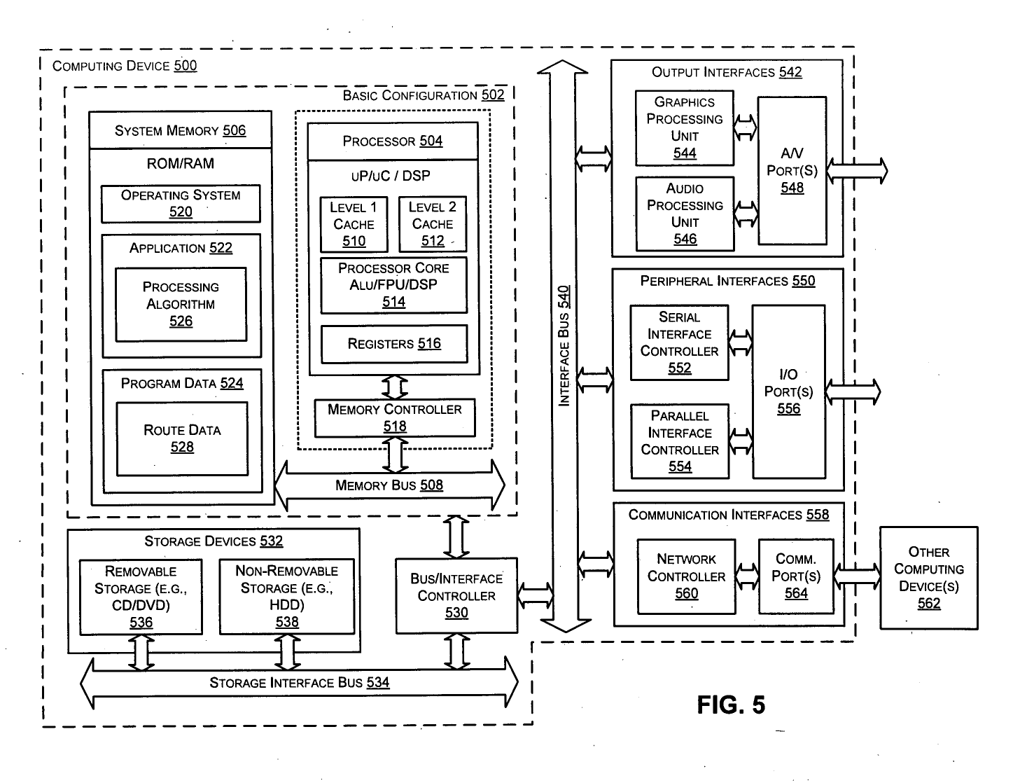

FIG. 5 is a block diagram illustrating an example computing device 500 that may be configured to determine a route in a:network according to one or more of the disclosed embodiments described herein. For example, computing device 500 may be one of the nodes of network 100 shown in FIGS. 1-3. In a very basic configuration 502, computing device 500 typically includes one or more processors 504 and system memory 506. A memory bus 508 can be used for communicating between the processor 504 and the system memory 506.

Depending on the desired configuration, processor 504 can be of any type including but not limited to a microprocessor (μP), a microcontroller (μC), a digital signal processor (DSP), or any combination thereof. Processor 504 can include one more levels of caching, such as a level one cache 510 and a level two cache 512, a processor core 514, and registers 516. The processor core 514 can include an arithmetic logic unit (ALU), a floating point unit (FPU), a digital signal processing core (DSP Core), or any combination thereof. A memory controller 518 can also be used with the processor 504, or in some implementations the memory controller 518 can be an internal part of the processor 504.

Depending on the desired configuration, the system memory 506 can be of any type including but not limited to volatile memory (such as RAM), non-volatile memory (such as ROM, flash memory, etc.) or any combination thereof. System memory 506 typically includes an operating system 520, one or more applications 522, and program data 524. Application 522 includes algorithms 526 that may be arranged to perform any of the functions shown in FIGS. 2-4 and described herein, for example, depending on a configuration of the computing device 500. Program Data 524 may include route data 528 related to route requests, active routes in which the computer device 500 is a participant, and/or other data related to determining and managing routes in a network, for example. In some example embodiments, application 522 can be arranged to operate with program data 524 on the operating system 520. This described basic configuration is illustrated in FIG. 5 by those components within dashed line 502.

Computing device 500 can have additional features or functionality, and additional interfaces to facilitate communications between the basic configuration 502 and any required devices and interfaces. For example, a bus/interface controller 530 can be used to facilitate communications between the basic configuration 502 and one or more data storage devices 532 via a storage interface bus 534. The data storage devices 532 can be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 506, removable storage 536 and non-removable storage 538 are all examples of computer storage media. Computer storage media includes, but is not limited to, RAM, ROM, EEPROM, flash memory or other memory technology, CD-ROM, digital versatile disks, (DVD) or other optical storage, magnetic cassettes, magnetic tape, magnetic disk storage or other magnetic storage devices, or any other medium which can be used to store the desired information and which can be accessed by computing device 500. Any such computer storage media can be part of device 500.

Computing device 500 can also include an interface bus 540 for facilitating communication from various interface devices (e.g., output interfaces, peripheral interfaces, and communication interfaces) to the basic configuration 502 via the bus/interface controller 530. Example output interfaces 542 include a graphics processing unit 544 and an audio processing unit 546, which can be configured to communicate to various external devices such as a display or speakers via one or more A/V ports 548. Example peripheral interfaces 550 include a serial interface controller 552 or a parallel interface controller 554, which can be configured to communicate with external devices such as input devices (e.g., keyboard, mouse, pen, voice input device, touch input device; etc.) or other peripheral devices (e.g., printer, scanner, etc.) via one or more I/O ports 556. An example communication interface 558 includes a network controller 560, which can be arranged to facilitate communications with one or more other computing devices 562 over a communication connection via one or more communication ports 564. The communication connection is one example of a communication media. Communication media may typically be embodied by computer readable instructions, data structures, program modules, or other data in a modulated data signal, and includes any information delivery media. A “modulated data signal” can be a signal that has one or more of its characteristics set or changed in such a manner as to encode information in the signal. By way of example, and not communication media can include wired media such as a wired network or direct-wired connection, and wireless media such as acoustic, radio frequency (RF), infrared (IR) and other wireless media. In some examples, the term computer readable media as used herein can include storage media, communication media, or both.

Computing device 500 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 can also be implemented as a personal computer including both laptop computer and non-laptop computer configurations, or other computer configurations.

The present disclosure is not to be limited in terms of the particular embodiments described in this disclosure, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or apparatuses which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as. “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example; as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention “a system having at least one of A, B, and C” would include but not be limited to systems that have A alone, B alone, C alone, A and B together, A and C together, B and C together, and/or A, B, and C together; etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and for A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc.

As a non-limiting example, each range discussed: herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be: understood by one skilled in the art, a range includes each individual member. Thus, for example, a group having 1-3 members refers to groups having 1, 2, or 3 members. Similarly, a group having 1-5 members refers to groups having 1, 2, 3, 4, or 5 members, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims,

1. A method comprising:
determining a set of one or more neighbor nodes that are within wireless communications range of a current node;
determining that a route is needed from a source node to a destination node;
selecting a first neighbor node of the set of one or more neighbor nodes in response to determining that the route is needed from the source node to the destination node, wherein the first neighbor node is a neighbor node of the set of neighbor nodes that is located closest to the destination node; and
initiating the transmission of a route-request message from the current node to the first neighbor node, wherein the route-request message comprises information identifying the destination node.

2. The method of claim 1, wherein the route-request message comprises a source identifier corresponding to a source node that originated the route-request message, a destination identifier corresponding to the destination node, and location information corresponding to the destination node.

3. The method of claim 1, further comprising receiving a route-reply message at the current node in response to the route-request message, wherein the route-reply message comprises information associated with a route from the source node to the destination node.

4. The method of claim 3, further comprising updating a list of one or more routes at the current node based on the route-reply message.

5. The method of any of claim 1, further comprising:
determining that a route to the destination node should not include the first neighbor node;
selecting a second neighbor node in response to determining that the route to the destination node should not include the first neighbor node; and
initiating the transmission of the route-request message from the current node to the second neighbor node.

6. The method of claim 5, further comprising refraining from sending at least one subsequent route-request message associated with the destination node to the first neighbor node in response to determining that the route to the destination node should not include the first neighbor node.

7. The method of claim 1, wherein the current node is the source node, and wherein determining that the route is needed from the source node to the destination node is based on data originating at the current node.

8. The method of claim 1, wherein the current node is an intermediate node that is located between the source node and the destination node, and wherein determining that the route is needed from the source node to the destination node is based on receiving a route-request message.

9. The method of claim 1, wherein selecting a first neighbor node from the set of one or more neighbor nodes in response to determining that the route is needed from the source node to the destination node comprises:
calculating, for each neighbor node of the set of one or more neighbor nodes, a corresponding intersect point where a line drawn from the neighbor node would perpendicularly intersect a reference line defined by the equation y(x)=((y_{d}−y_{c})/(x_{d}−x_{c}))*(x−x_{c})+y_{c}, wherein (x_{c}, y_{c}) represents a location of the current node, wherein (x_{d}, y_{d}) represents a location of the destination node, and wherein the first neighbor node has a corresponding intersect point on the reference line that is closest to the destination node.

10. A computing device comprising:
one or more communications interfaces; and
one or more processors configured to determine a set of one or more neighbor nodes that are within wireless communications range of the computing device, select a first neighbor node of the set in response to determining that a route is needed from a source node to a destination node, and initiate the transmission of a route-request message from the one or more communications interfaces to the first neighbor node, wherein the first neighbor node is the neighbor node of the set that is located closest to the destination node.

11. The computing device of claim 10, wherein the one or more processors are configured to update a list of one or more routes based on a route-reply message received in response to the route-request message.

12. The computing device of claim 10, wherein the one or more processors are configured to determine that a route to the destination node should not include the first neighbor node, select a second neighbor node in response to determining that the route to the destination node should not include the first neighbor node, and initiate the transmission of a route-request message from the computing device to the second neighbor node.

13. The computing device of claim 12, wherein the one or more processors are configured to refrain from sending at least one subsequent route-request message associated with the destination node to the first neighbor node in response to determining that the route to the destination node should not include the first neighbor node.

14. The computing device of claim 10, wherein the computing device corresponds to the source node, and wherein the one or more processors are configured to determine that the route is needed from the source node to the destination node based on data originating at the computing device.

15. The computing device of claim 10, wherein the computing device corresponds to an intermediate node located between the source node and the destination node, and wherein the one or more processors are configured to determine that the route is needed from the source node to the destination node is based on receiving a route-request message.

16. A tangible computer readable media having instructions stored thereon, the instructions comprising:
instructions for determining a set of one or more neighbor nodes that are within wireless communications range of a current node;
instructions for determining that a route is needed from a source node to a destination node;
instructions for selecting a first neighbor node of the set of one or more neighbor nodes in response to determining that the route is needed from the source node to the destination node, wherein the first neighbor node is a neighbor node of the set of one or more neighbor nodes that is located closest to the destination node; and
instructions for initiating the transmission of a route-request message from the current node to the first neighbor node, wherein the route-request message comprises information identifying the destination node.

17. The tangible computer readable media of claim 16, further comprising instructions for updating route data related to one or more routes based on a route-reply message received in response to the route-request message.

18. The tangible computer readable media of claim 16, further comprising:
instructions for determining that a route to the destination node should not include the first neighbor node;
instructions for selecting a second neighbor node in response to determining that the route to the destination node should not include the first neighbor node; and
instructions for initiating the transmission of a route-request message to the second neighbor node.

19. The tangible computer readable media of claim 16, wherein the instructions for determining that the route is needed from the source node to the destination node comprises at least one of analyzing data originating at the current node or analyzing a route-request message received from another node.

20. The tangible computer readable of claim 16, wherein the instructions for selecting a first neighbor node from the set of neighbor nodes comprises:
instructions for calculating for each neighbor node of the set of neighbor nodes, a corresponding intersect point where a line drawn from the neighbor node would perpendicularly intersect a reference line defined by the equation y(x)=((y_{d}−y_{c})/(x_{d}−x_{c}))*(x−x_{c})+y_{c}, wherein (x_{c}, y_{c}) represents a location of the current node, wherein (x_{d}, y_{d}) represents a location of the destination node, and wherein the selected first neighbor node has a corresponding intersect point on the reference line that is closest to the destination node.
